(19) United States
(12) Patent Application Publication
(10) Pub. No.: US 2007/0271540 A1
(43) Pub. Date: Nov. 22, 2007

(54) STRUCTURE AND METHOD FOR REDUCING SUSCEPTIBILITY TO CHARGING DAMAGE IN SOI DESIGNS

(75) Inventors: Chung-Ping Eng, Hopewell Junction, NY (US); Henry A. Bonges, Milton, VT (US); Jeffrey S. Zimmerman, Swanton, VT (US); Terence B. Hook, Jericho, VT (US)

Correspondence Address: CANTOR COLBURN LLP-IBM BURLINGTON, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/383,565

(22) Filed: May 16, 2006

(51) Int. Cl. G06F 17/50

(52) U.S. Cl. 716/10; 716/9

(57) ABSTRACT

Disclosed is a protection circuit for an integrated circuit device, wherein said protection circuit comprises: a first element connected to a gate of a first FET device; and a second element connected to a gate of a second FET device, wherein a drain/source of the first FET device and a drain/source of the second FET device are connected to a higher level connector and wherein the higher level connector eliminates a damaging current path between the first element and the second element.

### BACKGROUND

1. Field of the Invention

The present invention generally relates to protection circuitry and, more particularly, to a method and structure that includes a local charge-eliminating element between the source/drain and gate of silicon-over-insulator (SOI) transistors which may develop a voltage differential between the source/drain and gate during wafer fabrication.

2. Description of Background

One problem that exists when designing integrated circuits with silicon-over-insulator (SOI) transistors relates to the detection of which particular SOI transistors may be susceptible to charging damage, and to providing protection once such a susceptible device is identified. In SOI it is not possible to “tie down” a floating gate in the traditional sense, such as by adding a diode connection to the substrate or n-well. SOI technologies are inherently less susceptible to charging damage because both the source/drain and the gate tend to have similar antenna, so the potential of both nodes varies together. This is not, however, certain in all cases. The introduction of a charge-eliminating device or compensating antennas has been shown to reduce the propensity for damage; however, this approach is not always sufficient. If the connection between the source/drain and the gate nodes is too remote from the susceptible transistor, and the antennas connected to the source/drain and the gate of the transistor are too large, even a metallic shorting element may be not be of sufficiently low impedance to protect the transistor against damage.

### SUMMARY

Disclosed is a protection circuit for an integrated circuit device, wherein said protection circuit includes: a first element connected to a gate of a first FET device; and a second element connected to a gate of a second FET device, wherein a drain/source of the first FET device and a drain/source of the second FET device are connected to a higher level connector and wherein the higher level connector eliminates a damaging current path between the first element and the second element.

Also disclosed herein is a protection circuit for an integrated circuit device, wherein said protection circuit includes: a first element connected to a gate of a first FET device; a second element connected to a gate of a second FET device; wherein a drain/source of the first FET device and a drain/source of the second FET device are connected together, and the second element is connected through a higher level connector and wherein the higher level connector eliminates a damaging current path between the first element and the second element.

Further disclosed herein is a method of preventing charging damage in an integrated circuit including: assigning a region to an integrated circuit design; identifying a pair of devices within the region as susceptible to charging damage; and modifying a structure of the region of the integrated circuit design, wherein the modification eliminates the potential for charging damage.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF DRAWINGS

The invention will be better understood from the following detailed description with reference to the drawings, in which:

FIG. 1 is a schematic diagram of an exemplary SOI circuit device susceptible to charging damage;

FIG. 2 is a schematic diagram of a circuit device with a charge-eliminating element, in accordance with an embodiment of the invention;

FIG. 3 is a schematic diagram of a circuit device with an alternatively located charge-eliminating element; and

FIG. 4 is a flow diagram illustrating a method for reducing susceptibility to charging damage in SOI designs, in accordance with a further embodiment of the invention.

### DETAILED DESCRIPTION

The present invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention in detail. The examples used herein are intended merely to facilitate an understanding of ways in which the invention may be practiced and to further enable those of skill in the art to practice the invention. Accordingly, the examples should not be construed as limiting the scope of the invention.

To facilitate clarity, the invention will be described using a silicon on insulator (SOI) circuit example. In the foregoing example, certain IC design structures, such as SOI transistors, produce the possibility of charging damage. For example, it is possible to create a differential antenna by the arrangement of vias within the metal line. Vias placed in narrow metal lines have a larger aspect ratio than vias placed well within large metal plates, and may therefore charge to a different potential when exposed to a plasma. This occurs in either via-first or trough-first processes, although the specific sensitive process then varies. In generally, if the gate and source/drain of a FET have different via/metal configurations, then charging damage can occur. Elements connecting the source/drain node and the gate node together, either a metallic short, or a diode-connected FET, reduces the propensity of damage. However, in extreme cases this may not be sufficient if the protecting element is located too distant from the device to be protected.

To address this problem, the chip design is segmented into multiple regions prior to tracing the electrical nets, and each FET is examined to ensure that any source/drain node of the FET is connected to only one transistor whose gate is connected to a large antenna. Multiple methods for eliminating the potential for charging damage may be used. In one example, the connection to one of the large antennas may be made at a higher wiring level to eliminate the potential for charging damage. In another example, the connection between the two FETs may be made at a higher wiring level in the SOI circuit to eliminate the potential for charging damage.

During processing, the circuit configuration is not complete, so at each level of wiring (M1, M2, etc.) the potential for charging damage is reassessed. The total number of nodes to be examined reduces as higher levels of wiring are considered, until there is effectively only one single node at the final wiring level. Various degrees of refinement are possible, depending on the specifics of the particular technology. For example, the damage may be observed to occur only on devices of a particular type, and in a particular configuration. One such example is that “thick”(e.g., >2 nm) pFETs with high-aspect ratio vias on the gate node may be the only susceptible configuration, and all others may be safely ignored. In exemplary embodiments, the tracing process is performed assuming all metals and diffusions are conductive.

In exemplary embodiments, different processes may be implemented to determine whether a voltage differential exists across a series of two SOI transistors. One method compares the conductive shapes which are connected to the gate and source/drain to identify shapes with large charge accumulation properties (e.g., antenna). This can be accomplished using any conventional shapes processing program. For example, the method may obtain the length, width, height, etc., dimensions of the various conductors from the conventional shapes processing program and uses that data to perform the shapes comparison. In one embodiment, a via embedded in a long thin metal wire will have different antenna characteristics than a via within a wide plate. If the shapes are not balanced, the charge accumulation is likely to be unbalanced.

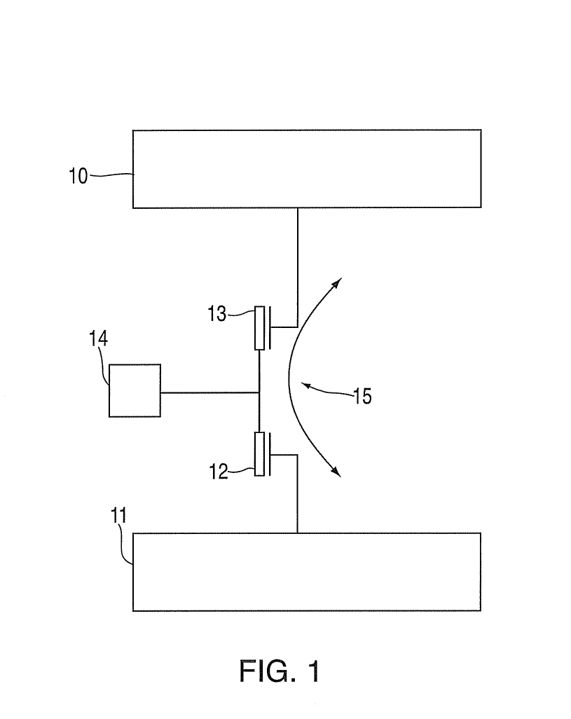

FIG. 1 illustrates a schematic diagram of an exemplary SOI circuit susceptible to charging damage. A first device 12 is connected to a second device 13, both of which are potentially susceptible to charging damage, as illustrated by a current 15. Device 12 may be, for example, a transistor, which has its gate connected to a large antenna 11 and its source/drain connected to the device 13. Likewise, device 13 may be, for example, a transistor, which has its gate connected to a large antenna 10 and its source/drain connected to the device 12. As mentioned above, devices 12 and 13 are identified as having the potential to be damaged because the charge accumulation on antenna 11 may be substantially different than the charge accumulation on antenna 10. The physical separation of the two antennas means that each may possess a different potential, due to lateral nonuniformities. In exemplary embodiments, the devices 12 and 13 may also be connected to a small antenna 14.

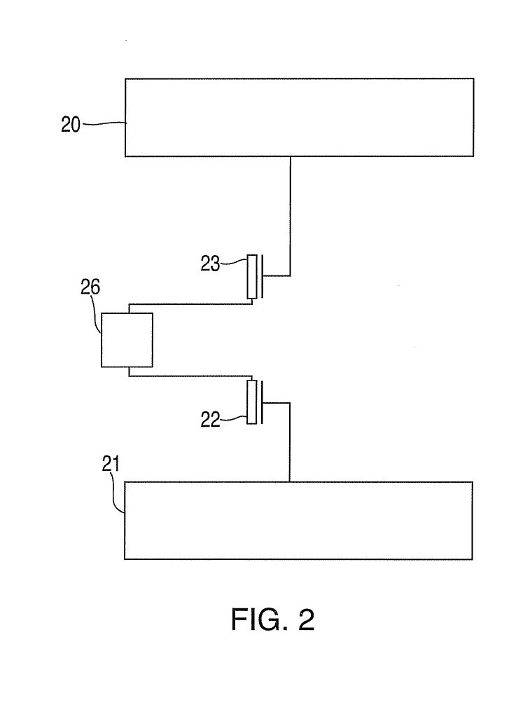

FIG. 2 illustrates a schematic diagram of an exemplary circuit that has been designed to reduce eliminate the risk of charging damage, in accordance with an embodiment of the invention. A first device 22 and a second device 23 are connected to each other through a higher level connection 26. The higher level connection 26 disrupts the potentially damaging current path that could lead to charging damage. Device 22 may be, for example, a transistor, which has its gate connected to a large antenna 21 and its source/drain connected to the higher level connection 26. Likewise, device 23 may be, for example, a transistor, which has its gate connected to a large antenna 10 and its source/drain connected to the higher level connection 26. By connecting the device 22 and 23 at the higher level connection 26, the circuit design eliminates the damaging current path which made the circuit susceptible to charging damage.

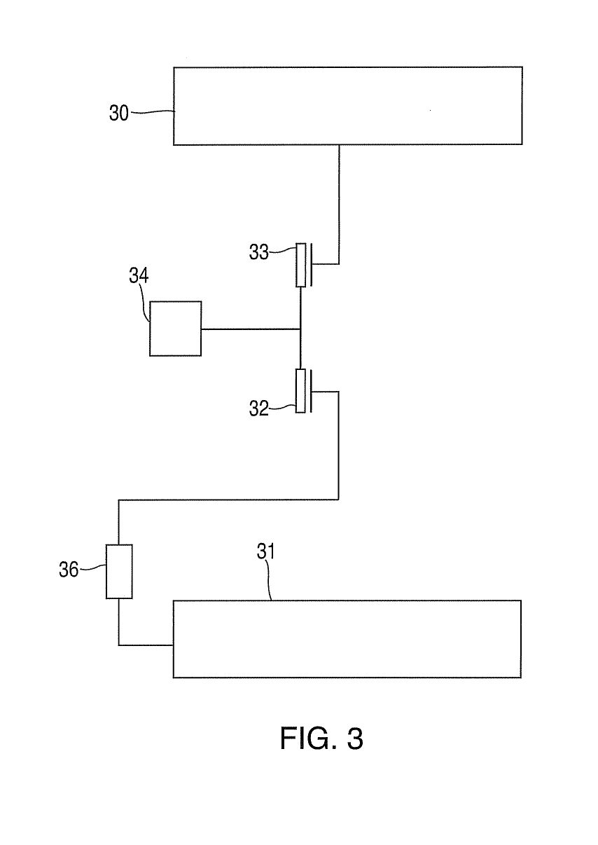

FIG. 3 illustrates another schematic diagram of an exemplary circuit that has been designed to eliminate the risk of charging damage, in accordance with an alternative embodiment of the invention. A first device 32 is connected to a second device 33, which both may be connected to a small antenna 34. Device 32 may be, for example, a transistor, which has its gate connected to a large antenna 31 through the higher level connection 36 and its source/drain connected to the device 33. The device 33 may be, for example, a transistor, which has its gate connected to a large antenna 30 and its source/drain connected to the device 32. By connecting the device 32 to the large antenna 31 through the higher level connection 36, the circuit design eliminates the damaging current path between the two large antennas 30 and 31, which made the circuit susceptible to charging damage.

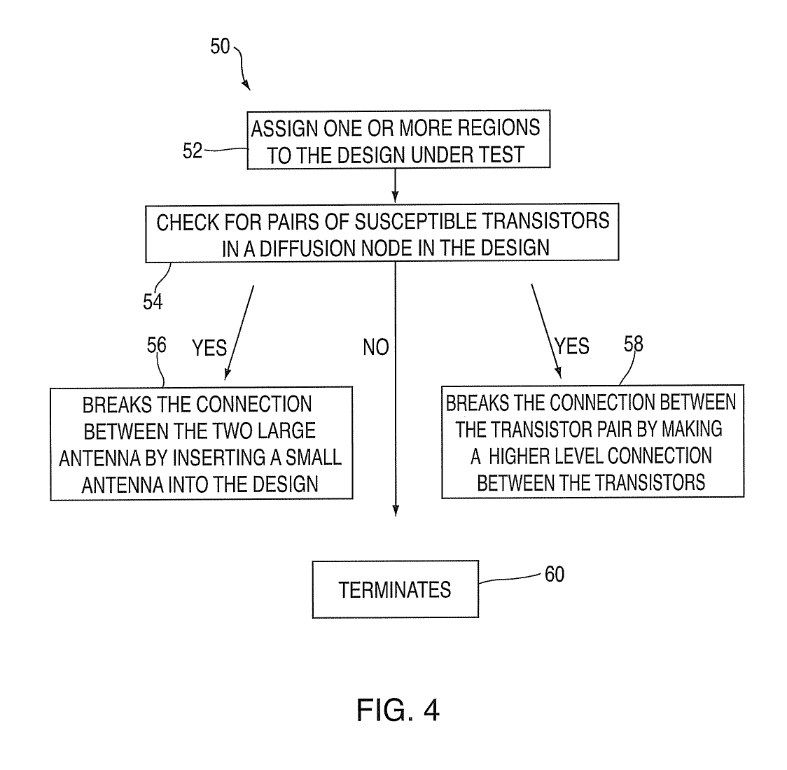

FIG. 4 illustrates a flow diagram of a method 50 for identifying susceptible devices and eliminating the risk of charging damage to the identified devices. The first step in the method 50 is to assign one or more regions to the design under test (DUT), as shown at process block 52. The next step in the method 50 is to check for pairs of susceptible transistors in a diffusion node in the design, as shown at process block 54. If a susceptible pair of transistors is found in a diffusion node the method may proceed to either process block 56 or 58. At process block 56, the method 50 breaks the connection between the two large antennas by inserting a higher level connection into the design (e.g., as shown in FIG. 3). At process block 58, the method 50 breaks the connection between the transistor pair by making a higher level connection between the transistors (e.g., as shown in FIG. 2). If the method 50 does not find a susceptible pair of transistors in a diffusion node, the method returns to process block 54 and checks another diffusion node until all diffusion nodes have been checked. After all diffusion nodes have been checked, the method 50 terminates at process block 60.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of preventing charging damage in an integrated circuit comprising:
assigning a region to an integrated circuit design;
identifying a pair of devices within the region as susceptible to charging damage; and
modifying a structure of the region of the integrated circuit design, wherein the modification eliminates the potential for charging damage, wherein the pair of devices is a pair of transistors.

2. The method of claim 1, wherein the pair of devices are series connected to a pair of antennas.

3. The method of claim 2, wherein modifying a structure of the region of the integrated circuit design includes changing the electrical configuration of at least one of the antenna to eliminate potential charging damage.

4. The method of claim 2, wherein modifying a structure of the region of the integrated circuit design includes changing the electrical connection placement of the two transistors to eliminate potential charging damage.

5. The method of claim 3, wherein changing the electrical configuration of at least one of the antenna includes disconnecting one of the antenna from the pair of the devices.

6. The method of claim 4, wherein changing the electrical connection placement of the two transistors includes moving the connection between the two transistors to a higher level.

7. The method of claim 2, wherein modifying a structure of the region of the integrated circuit design includes changing the electrical connection placement of the two transistors to eliminate potential charging damage.

8. A protection circuit for an integrated circuit device, wherein said protection circuit comprises:
a first element connected to a gate of a first FET device; and
a second element connected to a gate of a second FET device the small antenna,
wherein a drain/source of the first FET device is connected to a drain/source of the second FET device and wherein the higher wiring level connector small antenna eliminates a damaging current path between the first element and the second element.

9. A protection circuit for an integrated circuit device, wherein said protection circuit comprises:
a first element connected to a gate of a first FET device; and
a second element connected to a gate of a second FET device,
wherein a drain/source of the first FET device and a drain/source of the second FET device are connected to a higher level connector, and
wherein the higher wiring level connector eliminates a damaging current path between the first element and the second element.
